(19) United States
(12) Patent Application Publication
(10) Pub. No.: US 2012/0325221 A1
(43) Pub. Date: Dec. 27, 2012

(54) Lightweight Respirator

(75) Inventor: Thong Quoc Tran, Renton, WA (US)

(73) Assignee: Thong Quoc Tran, Renton, WA (US)

(21) Appl. No.: 13/168,864

(22) Filed: Jun. 24, 2011

(51) Int. Cl. A62B 18/02; A62B 23/02; A62B 19/00

(52) U.S. Cl. 128/206.17

(57) ABSTRACT

This invention relates to respirator, a half face mask with the shape of a concave-rectangular cup that fits the facial features comfortably. The mask covers user's mouth and nostrils to provide a breathing chamber and has three opening ports, one on the bottom receiving the filter cartridge and two of the same dimension on the sides receiving the exhalation tubes. The three components are grooved-fitting embedded into the mask and have one-way air flow functionality controlled by the mean of flapper valve mechanism. The filter cartridge contains layers of mesh and chemical compounds to filter dust particles, destroy carbon monoxide and absorb other toxic gases. The present invention offers a respirator having the functionality of a gas mask but aesthetic-simplicity shape of a half face mask which commuters can conveniently wear in polluted metropolitan or hazardous atmosphere to prevent dust particles and toxic gases go into wearer's lung.

### REFERENCES CITED

U.S Patent Documents

| | | |
|---|---|---|
| 2,695,020 | November 1954 | Glidden |
| 2,898,908 | August 1959 | Sovinsky |
| 3,220,408 | November 1965 | Silverberg |
| 4,595,003 | June 1986 | Shoemaker et al. |
| 4,850,346 | July 1989 | Michel et al. |

### STATEMENT REGARDING FEDERALLY SPONSORED RESEARCH OR DEVELOPMENT

Not applicable

### FIELD OF THE INVENTION

This invention relates to breathing equipment and in particular to a simple respirator providing not only protection from unhealthy air but also conveniences and artistic appearance which users can wear for daily commute in polluted metropolitan.

### BACKGROUND OF THE INVENTION

Respirator has been invented as early as in the early nineteen century to protect wearer from life threatening environments such as fire, deep mining, and diving. Along with the history, when new hazardous conditions occur such as contamination areas, pandemic diseases, toxic working places, and chemical warfare; various respirators, gas masks, were invented to provide needed protections.

Generally, most prior art respirators utilize face mask, half-face or full-face, covering the mouth and nostrils and providing a breathing chamber. The respirators are provided with several ports, flapper valves or mechanical valves to control one-way air flow of inhalation and exhalation, one or two mechanical or replaceable filter cartridges are mounted to inhalation ports to filter out unwanted agents in the air. The filter cartridge contains various absorptive compounds to protect wearer from various hazardous environments. Such respirators desirably perform well in life-threatening time and situations but have some disadvantages.

Prior art respirators are bulky and heavy; most of them have external filter which may be clogged under rain, some have connection tube for inhalation or exhalation, some come with the hood that covers the head. These features causing discomfort, limit head motion and vision to the wearer.

Prior art respirators are designed aiming more on protective purpose but less on preventive mean. In analogy, user obliged to wear them when encounter life threatening or hazardous situations but hardly wear them for daily commuting wherein milder polluted environment also exists.

Prior art respirators are expensive that the most needed populations in the worse regions of the globe, such as underdeveloped countries, can't afford.

Prior art respirators appear cumbersome and lack of adaptive, aesthetic appearances. These imperfections discourage people wear it as an ordinary necessity. In analogy, a biker wears goggle to protect his eyes but not a gas mask to protect his lung when commuting in polluted metropolitan.

Known prior art includes:

U.S. Pat. No. 2,695,020 to Glidden, issued Nov. 23, 1954; U.S. Pat. No. 2,898,908 to Sovinsky, issued Aug. 11, 1959; U.S. Pat. No. 3,220,408 to Silverberg, issued Nov. 30, 1965; U.S. Pat. No. 4,595,003 to Shoemaker et al., issued Jun. 17, 1986; U.S. Pat. No. 4,850,346 to Michel et al., issued Jul. 25, 1989.

### OBJECTS OF THE INVENTION

The general object of the present invention is to provide a face mask respirator that overcomes disadvantages disclosed above.

Another object of the present invention is to provide an improved face mask respirator which enhances comfort, convenience, and mobility for the wearer.

Another object of the present invention is to provide a face mask respirator which can operate in any weather condition.

Another object of the present invention is to provide a face mask respirator at low cost which more population can afford.

The most important object of the present invention is to provide a face mask respirator with simple, light, and artistic shape displays no awkward appearance on the wearer. With this objective in view, the present invention can replaces the ineffective improvised-mask while functioning as a gas mask and becomes an ordinary necessity instead of a special needed device; the user can wear it for daily commuting in polluted metropolitan or for whenever needed.

### SUMMARY OF THE INVENTION

The present invention directed to a respirator comprises simple, artistic mask mold of silicone rubber with the shape of a concave rectangular cup that covers the mouth and nostrils; one filter cartridge; two identical exhalation tubes; and a set of strap suspension.

The filter cartridge integrated on the mask's bottom side to minimize the cumbersome, awkward appearance and conceal it from the rain; the said filter cartridge contains filter media consists of layers of mesh and absorbent compounds and employs a butterfly flapper valve at downstream end to control one-way inhalation.

The exhalations tubes are also integrated on the mask's sides to minimize its appearance; the said tube employs a disk-shape flapper valve at the inner annulus wall to control one-way exhalation.

The strap suspension set comprises four elastic straps having eyelet adjusters at one end where they snugly mount to the mask's mushroom-head bosses; at the other end of the straps, two connect to eyelet adjusters while the other two connect to hook adjusters to provide coupling pairs; the straps wrap around the head, one pair above the ear and one below the ear to secure the respirator in place, comfortably.

Thus, the present invention incorporates a unique respirator with simple design, low cost, artistic display, and convenient features that enhance its usability and popularity over the prior art.

### BRIEF DESCRIPTION OF THE DRAWINGS

FIG. 1A and FIG. 1B show isometric views of a respirator of the present invention demonstrating the device is fully assembled.

FIG. 2 is perspective view of the half face mask.

FIG. 3 is isometric view of the filter cartridge including view 3B showing filtration contents.

FIG. 3A is exploded view of the filter cartridge showing order of assembly of various parts.

FIG. 4 is perspective view of the filter tube.

FIG. 5 is perspective view of the filter cap.

FIG. 6 is perspective view of the exhalation tube.

FIG. 6A is exploded view of the exhalation tube showing order of assembly of various parts.

FIG. 6B is isometric view demonstrates construction of the exhalation tube's housing.

### DETAIL DESCRIPTION OF THE PREFERRED EMBODIMENT

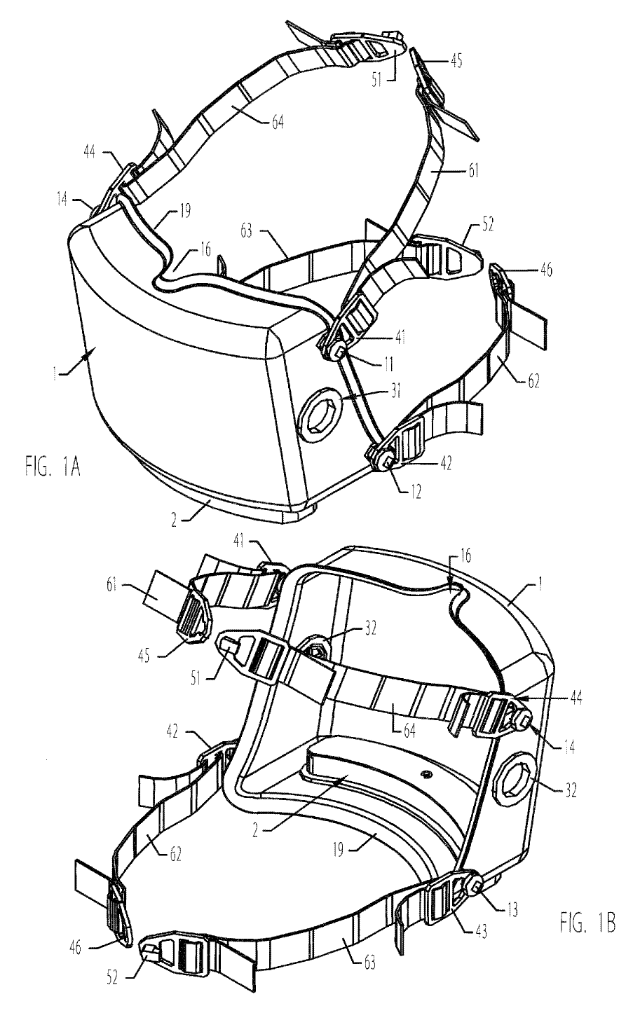

FIG. 1A and FIG. 1B show front and back isometric views of a preferred embodiment, the respirator of this invention, respectively. The respirator comprises one half face mask 1; one filter cartridge 2, two identical exhalation tubes 31, 32; six identical eyelet adjusters 41, 42, 43, 44, 45, 46; two identical hook adjusters 51, 52; and four identical elastic straps 61, 62, 63, 64.

The mask 1 firmly covers the mouth and nostrils. The filter cartridge 2 is grooved-mounted on the bottom of the mask; the unique feature is that the filter cartridge is partially embedded into the mask's breathing chamber to eliminate the cumbersome appearance as seen on most of industrial gas mask. The exhalation tubes 31 and 32 are also grooved-mounted on the mask's sides for the like concealment purpose. Four eyelet adjusters 41, 42, 43, 44 snugly attached to the mask's four mushroom-head bosses 11, 12, 13, 14, respectively. One end of four elastic straps 61, 62, 63, 64 are loop-locked into the slots of eyelet adjusters 41, 42, 43, 44, respectively; the other end of elastic strap 61 and 62 are also loop-locked into slots of eyelet adjuster 45 and 46, respectively; while the other end of elastic strap 63 and 64 are loop-locked into slots of hook adjusters 51 and 52, respectively; this configuration provides coupling pairs in which the eyelet adjuster 45 engages with the hook adjuster 51, likewise for the eyelet adjuster 46 with the hook adjuster 52, to secure the respirator on the wearer. Further details of each component will be described in individual drawing.

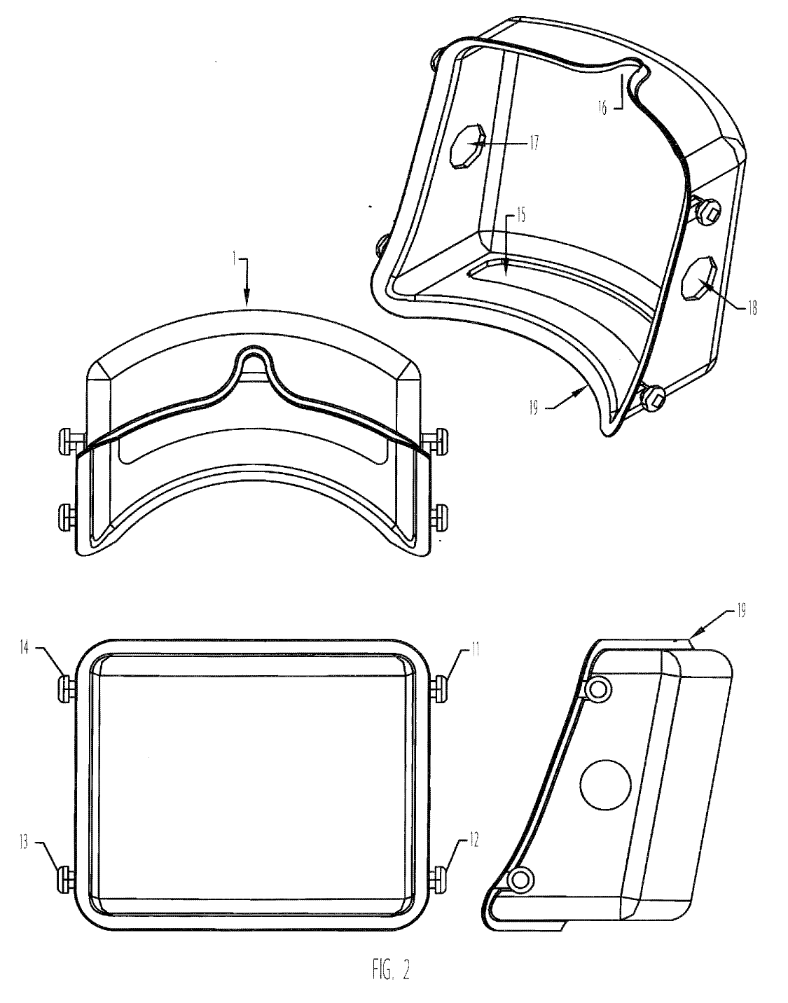

FIG. 2 shows a preferred embodiment of a half face mask 1. The mask 1 is molded of silicone rubber with the shape of a concaved rectangular cup having all edges filleted. The base seam, including nose curve 16, employs the rim 19 to contour and seal general facial features comfortably. Four identical mushroom-head bosses 11, 12, 13, 14 are incorporated on the mask, two on each side; these bosses have stem diameter equal the eyelet's diameter of the eyelet adjuster and function as pivoting posts where the eyelet adjusters can be snugly attached onto and rotate about.

Referring to FIG. 2, a concave-rectangular opening 15 and two identical circular openings 17 and 18 are incorporated. The opening 15 has its concave side in parallel with the mask's frontal side to optimize available area; and its geometry is identical with the periphery of the filter cartridge 2. The circular openings 17 and 18 have same periphery as of exhalation tubes 31 and 32.

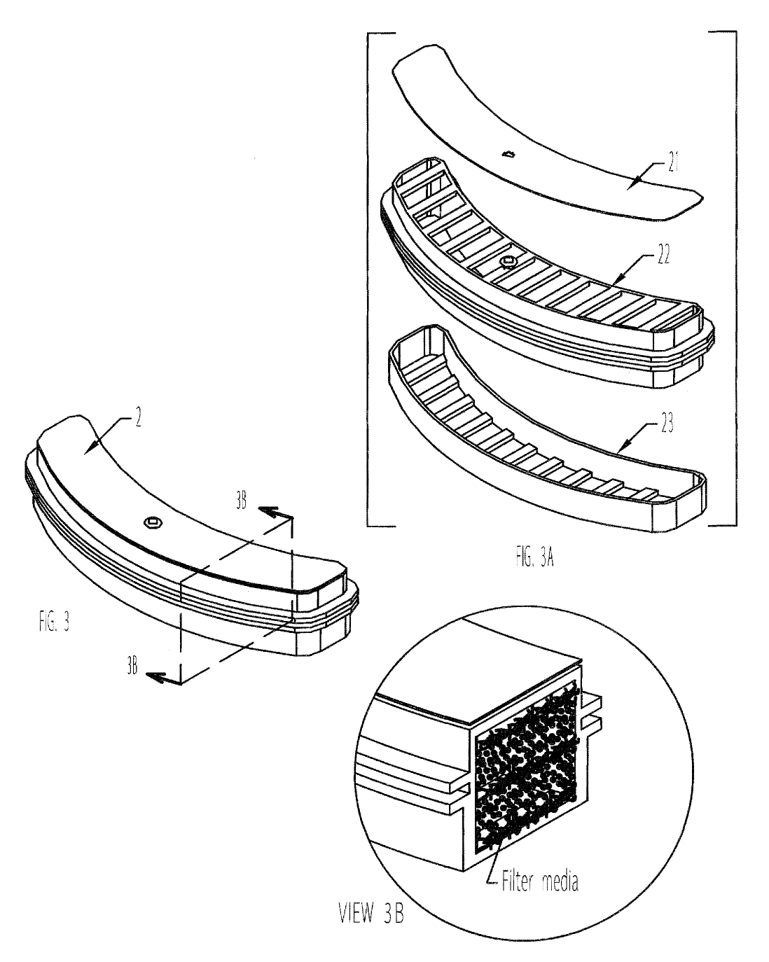

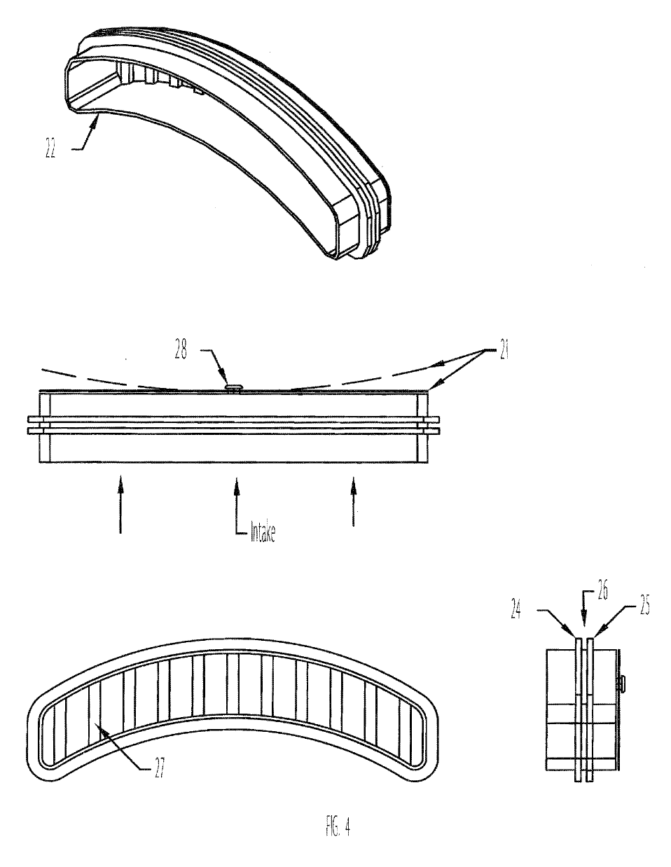

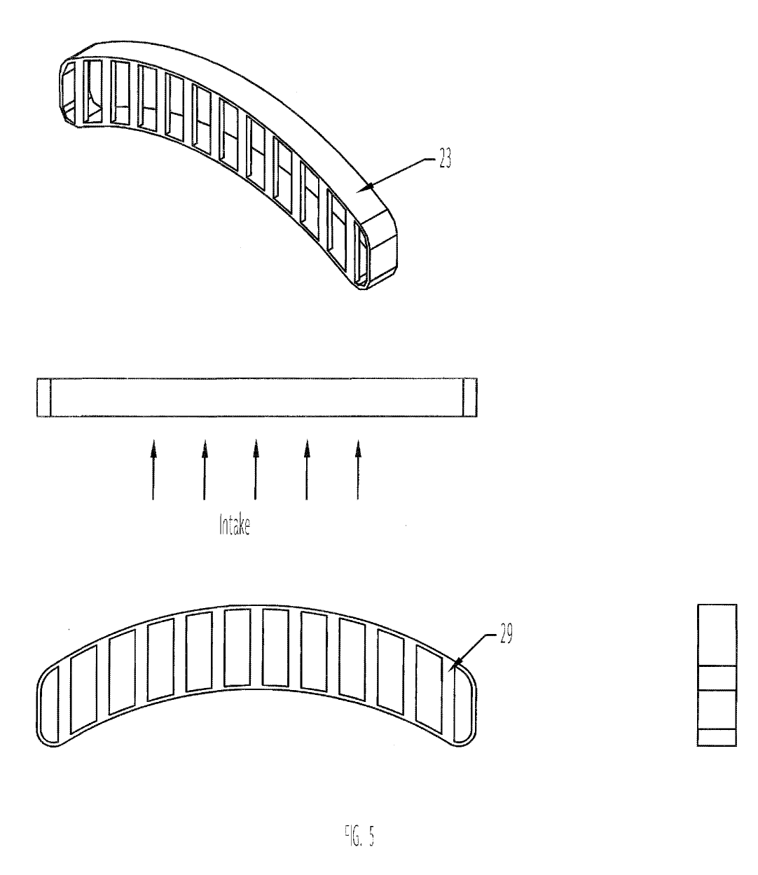

FIG. 3 shows a preferred embodiment of a filter cartridge 2 comprises the butterfly valve 21, filter tube 22 and the cap 23 as shown in exploded view, FIG. 3A. Further details will be described in FIG. 4 and FIG. 5. View 3B shows a cross section view of the filter cartridge 2 demonstrating filter media is filled. The filter media can be layers of mesh and absorbents such as activated carbon, hopcalite or various filtering compounds with various characters for various types of filtering.

FIG. 4 is perspective view of filter tube 22. Providing a concave-ellipse tubular body and the groove 26, the filter tube 22 is precisely fitted onto the mask's opening 15 with the open-intake end facing down connecting to the atmosphere. The distance between flanges 24 and 25 equals the thickness of the mask 1 providing mounting edges that keep the filter cartridge 2 snugly tight on the mask 1. A row of ribs 27 form an inner wall to contain filter media while still yield enough open space for the air flow. The filter tube 22 has all radii corners for the conveniences of manufacturing and assembling.

Looking more particular at FIG. 4, the butterfly flapper valve 21 is secured on the mushroom-head post 28. The valve 21 moves in the direction of intake arrow into the dotted configuration when inhalation takes place; in reverse mode, said valve moves to flat position to block the air flow when exhalation takes place.

FIG. 5 shows a preferred embodiment of a filter cap 23. Basically, the cap has the same geometry as of the filter tube 22. The said cap has internal periphery identical to the external periphery of the filter tube 22 to enable the coupling. The said cap also has row of ribs 29 designed as an outer wall that contains filter media. The coupling ability between the filter tube 22 and the cap 23 allows the replacement of the filter media when it is saturated.

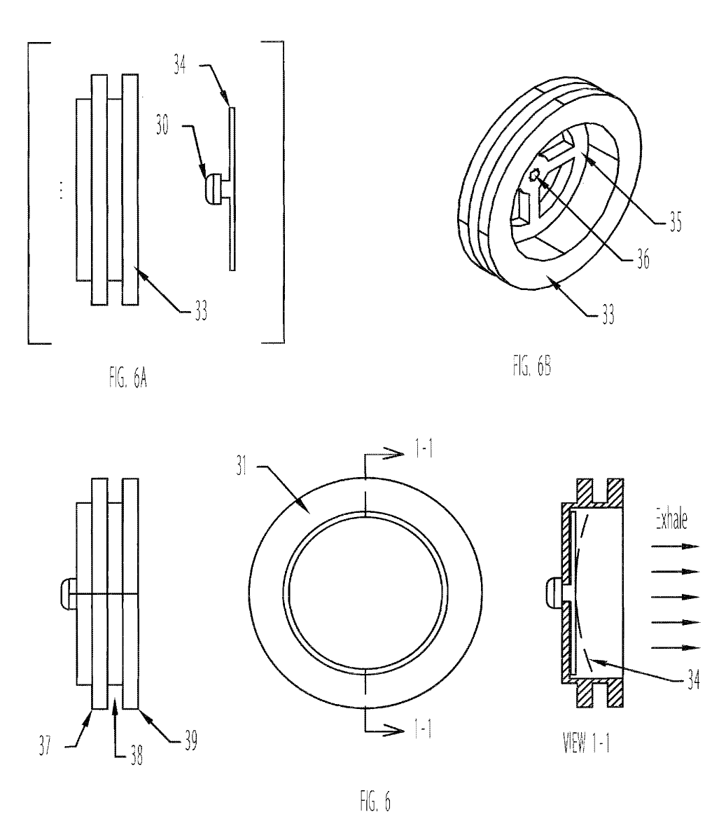

FIG. 6 shows a preferred embodiment of one of the two identical exhalation tubes, 31. The said tube comprises a housing 33 and a flapper valve 34 demonstrated in exploded view of FIG. 6A. As shown in FIG. 6B, the housing 33 is a short cylindrical tube having open outlet end and annulus wall 35 with reinforced crossbar at the intake end; at the center of the crossbar, a hole 36 is employed where the flapper valve 34 is secured onto by snapping the mushroom head 30 through the hole. The said housing incorporates two flanges 37 and 39 to form a groove 38 where the exhalation tube 31 is snugly mounted onto the mask 1 with the open outlet connects to the atmosphere. View 1-1 of FIG. 6 illustrates the flapper valve 34 moves in the direction of exhale arrow into the dotted line configuration when exhalation takes place; in reverse mode, the valve 34 moves to flat position to block the air flow when inhalation takes place.

Accordingly, FIGS. 1-8 show the embodiment of a simple, light, aesthetic respirator of this invention. Although conceptual operation, part designs, and assembly designs have been described in details, it will be apparent to those skilled in the art that further modifications can be made to the preferred embodiment without deviating from the scope of the present invention.

I claim:

1. A respirator comprising:
a mask that has the shape of concave-rectangular cup with wall thickness to covers the user's mouth and nostrils and provides a breathing chamber;
a filter cartridge tightly embedded at the bottom of the mask by the mean of grooved-fitting to minimize its appearance;
two identical exhalation tubes tightly embedded on two sides of the mask by the mean of grooved-fitting to minimize their appearances;
a set of strap suspension mounted on both sides of the mask to secure the respirator onto user's face.

2. A respirator according to claim 1, wherein said concave-rectangular cup means a facepiece mask having a concave front, a top, a bottom, and opposite sides.

3. A respirator according to claims 1 and 2, wherein said mask has thin curved-out rim at the base seam that contours along facial features to fit the user's face comfortably and is molded of silicone rubber; said mask also has one concave-rectangular opening port on the bottom, two identical circular opening ports on the sides, four mushroom-head bosses of which two posted on each side of the mask.

4. A respirator according to claim 1, wherein said filter cartridge comprises a concave-rectangular tube, a concave-rectangular cap and a butterfly flapper valve.

5. A respirator according to claim 4, wherein said concave-rectangular tube has its periphery equals to the mask's concave-rectangular opening port; the said tube has open-intake end, where the filtration contents can be filled or replaced, and rib-wall at the outlet end. A pair of flanges, mask's thickness apart, is molded around the intake end to form a groove where the mounting takes place.

6. A respirator according to claim 4, wherein said butterfly flapper valve fitted through a round mushroom-head post located downstream at the center of the rib-wall end of the concave-rectangular tube, said flapper valve has surface area covers the cartridge's periphery to control one-way intake air flow.

7. A respirator according to claim 1, wherein said exhalation tube is a short cylindrical tube has the same periphery as of the mask's circular opening ports. The said tube has open-outlet end for exhalation and annulus wall at the intake end; the annulus wall is reinforced by two crossed ribs with a small hole at the center where a flexible disk-shaped flapper valve is mounted on to control one-way exhale air flow; the disk-shape valve has substantial clearance to the annulus wall so it can flap freely. The exhalation tubes are mounted to the mask's opening ports with a grooved-flange.

8. A respirator according to claims 4 and 7, wherein said flapper valve is made of silicone rubber sheet; has a thickness of about 0.012 inches and a durometer value of about 20 Shore A.

9. A respirator according to claim 1, wherein said set of strap suspension comprises four elastic straps, two straps on one side of the mask connect to eyelet adjusters at both end, two straps on other side of the mask connect to eyelet adjusters at one end and hook adjusters at the other end.
